(19) United States
(12) Patent Application Publication
(10) Pub. No.: US 2010/0040065 A1
(43) Pub. Date: Feb. 18, 2010

(54) Two Division Method for Quality of Service (QoS)

(76) Inventor: Xuejun Lu, Montreal (CA)

Correspondence Address: LU, XUE JUN, 912-6550 SHERBROOKE WEST, MONTREAL, QC, H4B-1N6, CA

(21) Appl. No.: 12/192,176

(22) Filed: Aug. 15, 2008

(51) Int. Cl. H04L 12/56

(52) U.S. Cl. 370/395.21

(57) ABSTRACT

The present invention discloses a method for classifying the packets into two divisions in the IP network. The first division is for the packets of constant packet rate (CPR) flows, and another division is for non constant packet rate (NCPR) flows. The method comprising: controlling the sending packet rate of CPR flows; classifying and queuing the CPR packets into the first division and all other NCPR packets into the second division; using FQ (or WFQ) algorithm to schedule the packets from the two divisions. In the present invention, CPR flows and NCPR flows share the transmission media by using two different entities. In each computing node, packets of CPR flows have guaranty delivery without packet drop. Previous QoS methods, such as priority method, can be used inside the two divisions for QoS purpose.

### BACKGROUND OF THE INVENTION

1. Field of the Invention

The present invention relates to Quality of Service (QoS) mechanism in an Internet Protocol (IP) network and to a method therefore.

2. Description of the Related Art

Concept Definition

A constant packet rate (CBR) flow is a particular network flow which generates a constant number of packets in each period time from a computing node.

A non constant packet rate (NCBR) flow is a network flow which is not appointed as a CBR flow. Generally, all network flows are NCBR flows except some network flows are appointed to be CBR flows.

A division is a particular group of packets. There are only two kinds of divisions which are CBR division and NCBR division. The structure of division is a group of queues for storing packets and the simplest structure of division is a single FIFO queue.

The current Internet-based network provides only “best-effort” service without QoS (Quality of Service) guarantee. Package may be dropped when the network congestions occur. The application programs may handle the packet loss, or use a system protocol (such as TCP) for packet retransmission.

The “best-effort” service works fine for some traditional applications, such as email, file transfer protocol, etc. It is not suitable for some other applications which require one time packet delivery guarantee, such as live multimedia applications.

The QoS technologies and mechanisms, such as Integrated Service (IntServ), and Differentiated Service (DiffServ), have been presented. Nevertheless, the problem of packet loss in a packet-based network has not been resolved for live multimedia communications, such as voice, and video.

The IntServ is used for resource control in application flow level. Since it is difficult for IntServ method to maintain a large number of reservations for all flows, IntServ would not scale well with the growth of the Internet.

The currently accepted QoS approach is DiffServ. In DiffServ, packets are marked as different classes according to the type of service they need, and routers supporting DiffServ use multiple priority queues for packet transmission.

Because the service of the same class will share the resource of this class, and there will exist a certain degree of transmission competition between those services with the same priority, the end-to-end QoS may not be guaranteed for NCRP flows even though DiffServ method has been used.

Since there are many traffic types on the computer network, the live multimedia communications do not suppose to be the highest priority traffic. For example, the system management traffic may take higher priority than multimedia applications.

System management traffics are NCRP flows. The multimedia traffics can not have QoS guarantying in a lower priority under other NCRP traffics.

### SUMMARY OF THE INVENTION

The object of the present invention is to provide two independent divisions for CPR and NCPR flows while the two divisions share to use the transmission media.

The invention aims at a compound network shared by CPR division and NCPR division. The concept for the invention includes the following four considerations:

CPR flows is suitable for using a FQ/WFQ scheduler to separate and share the transmission media with NCPR flows.

The transmission competitions occur in one single division only. The cross effect of queuing delay has been removed between CPR and NCPR flows.

Packets of CPR division have QoS service of guaranteeing delivery with limited queuing delay and without packet dropping. The applications such as live multimedia communications can obtain guaranteeing network service.

This invention provides two parallel divisions and avoids the priority problem between CPR and NCPR flows. Furthermore, priority method can be used in both CPR and NCPR divisions for QoS purpose.

### BRIEF DESCRIPTION OF THE DRAWINGS

A more complete understanding of the present invention may be had by reference to the following detailed description when taken in conjunction with the accompany drawings wherein:

FIG. 1A illustrates a typical CPR flow of multimedia;

FIG. 1B illustrates the concept and the structure of a general CPR flow;

FIG. 2 illustrates the structure of a CPR flow generated in a sender according to the present invention;

FIG. 3 is a block diagram of a computing node according to the present invention;

FIG. 4 illustrates the compound of CPR and NCPR packets in a transmission media according to the present invention.

### DETAILED DESCRIPTION OF THE PREFERRED EMBODIMENTS

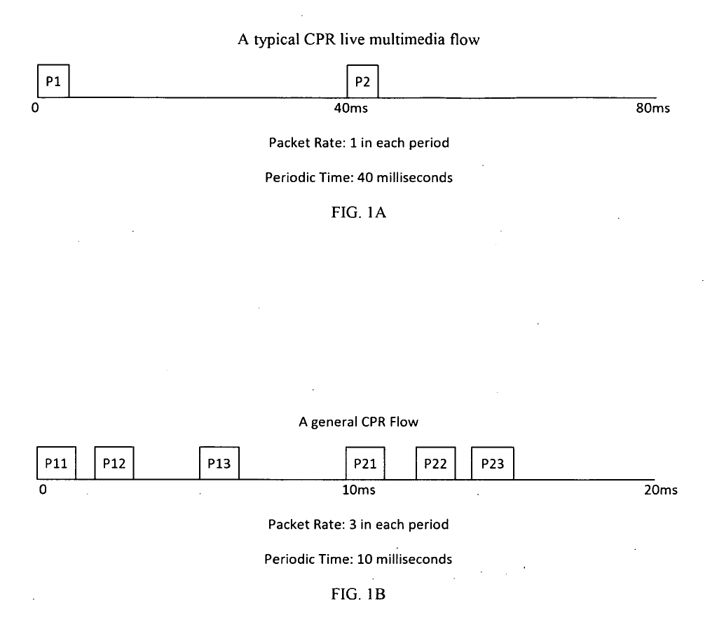

FIG. 1A illustrates a typical live multimedia flow, such as voice and video, which is a CPR flow with a 40 millisecond period.

FIG. 1B illustrates a general CPR flow, which produces a single or a multinumber of packets in a periodic time. In this drawing, the periodic time is 10 milliseconds and packet rate is 3 in a periodic time. The time requirement of the packets is not critical while the tolerance is to produce a constant number of packets in a periodic time for a CPR flow.

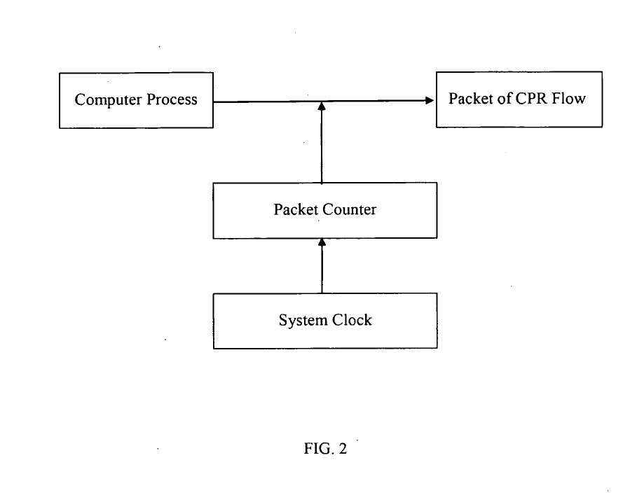

FIG. 2 illustrates the concept of generating a CPR flow in a sender according the present invention. A counter controls the sending number of packets which are generated from a program process while a system clock resets the counter by a system periodic time.

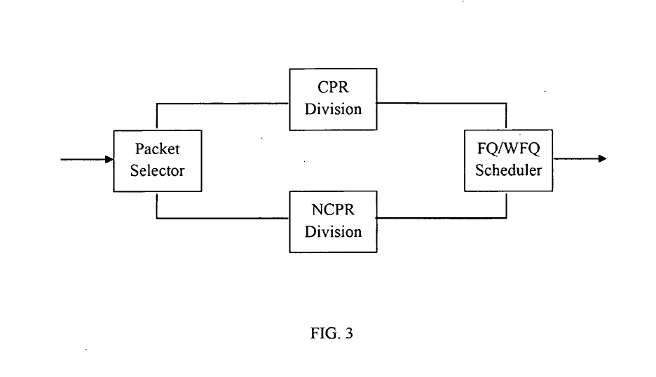

FIG. 3 is a block diagram of a computing node according to the present invention. A selector classifies the incoming packet into CPR division or NRPR division and a FQ/WFQ scheduler takes charge to schedule the packets from the two divisions.

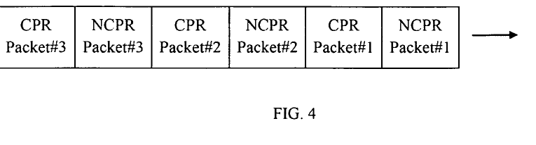

FIG. 4 illustrates the compound sequence of CPR and NCPR packets in a transmission media according to the present invention. In the physical media, CPR packets and NCPR packets are transmitted in turn.

Although the present invention has been described with reference to certain embodiments, it is obvious to the skilled in the art that many variations and changes in the present invention may be made without departing from the spirit of the present invention, and it is intended that the appended claims cover theses variations and changes without departing from the spirit of the present invention.

What is claimed is:

1. A network node for implementing a Quality of Service (QoS) mechanism in an Internet Protocol (IP) network, the network node comprising: a counter for controlling the output packets of a CPR flow; a selector for classifying an egress packet into a predetermined CPR division and a predetermined NCPR division; a FQ/WFQ scheduler for scheduling the packet from the two divisions.

2. The network node of claim 1, wherein the counter controls the process in the computing node to generate a constant number of packets in a periodic time as a CPR flow, if the flow is a CPR flow as required.

3. The network node of claim 1, wherein the selector classifies the packet as a CPR packet, if the packet belongs to a CPR flow.

4. A method for have Quality of Service (QoS) mechanism on a network path in an Internet Protocol (IP) network, said method operable on a network node, causing said network node to execute the steps of: classifying an egress packet as a CPR packet or a NCPR packet; storing the packet into CPR division or NCPR division; and scheduling the egress packet according to FQ/WFQ scheme from the two divisions.

5. The method of claim 4, wherein the classification comprises classifying the packet as a CPR packet, if the packet belongs to a CPR flow.
